(19) United States
(12) Patent Application Publication
(10) Pub. No.: US 2010/0088112 A1
(43) Pub. Date: Apr. 8, 2010

(54) LIFE INSURANCE FUNDED HEROIC MEDICAL EFFORTS TRUST FEATURE

(75) Inventors: Jacques Krasny, Rupert, VT (US); Karen Katen, New York, NY (US)

Correspondence Address: WOOD, HERRON & EVANS, LLP, 2700 CAREW TOWER, 441 VINE STREET, CINCINNATI, OH, 45202, US

(73) Assignee: KATEN & ASSOCIATES, LLC, New York, NY (US)

(21) Appl. No.: 12/572,110

(22) Filed: Oct. 1, 2009

Related U.S. Application Data
(60) Provisional application No. 61/102,683, filed on Oct. 3, 2008.

(51) Int. Cl. G06Q 40/00; G06Q 50/00

(52) U.S. Cl. 705/2; 705/4

(57) ABSTRACT

Provided herein are processes, including a computer implemented process, and an apparatus for making financial resources available for the treatment, medication, and other life extending expenses of life-expectancy reducing situations through life insurance policies. Also provided herein is medical network to provide up to date, accurate, and credible data related to life-expectancy reducing situations when time is of the essence.

### CROSS-REFERENCE TO RELATED APPLICATIONS

This nonprovisional application is related to and claims the benefit of U.S. Provisional Patent Application Ser. No. 61/102,683 to Krasny et al., entitled “LIFE INSURANCE FUNDED HEROIC MEDICAL EFFORTS TRUST FEATURE” (WHE Ref: WIND-02), and filed on Oct. 3, 2008. U.S. Provisional Patent Application Ser. No. 61/102,683 is incorporated by reference in its entirety and for all purposes herein.

### BACKGROUND OF THE INVENTION

An individual typically purchases health insurance from a health insurance company, either through his employer or individually, with the expectation that in return for payment of premiums to the health insurance company, the health insurance policy will cover his treatments and medications in the event of illness. However, the health insurance provided via the policy is often inadequate to meet the financial needs of an individual facing a medical situation or condition that may reduce life-expectancy, such as cancer.

As an example, for an individual with health insurance, annual out-of-pocket expenses for a drug used to treat colon, lung, and/or breast cancer may range from $10,000 to $20,000. For an individual without any health insurance, annual out-of-pocket expenses for the drug are even higher, and may range from $50,000 to $100,000 depending on the dosage. As a result, the high out-of-pocket costs may often preclude treatments and/or medicines that may significantly extend lives.

Moreover, health insurance policies will generally not cover a life-expectancy reducing situation, such as a cancer diagnosis, that is pre-existing and occurred before the individual applied for the policy. Some policies even deny coverage if the individual later learns that he or she had cancer at the time of purchase. The health insurance companies also place restrictions on which treatments and/or medicines are covered under the health insurance, as well as restrictions as to which healthcare providers will be reimbursed and restrictions regarding the extent that healthcare providers will be reimbursed (e.g., preferred providers versus nonpreferred providers). Health insurance companies also impose substantial deductibles and co-pay requirements to be paid by the patient, and caps on total treatment expenditures. Other policies contain time limits that require waiting periods of 30 days or even several months before coverage begins, while others stop paying benefits after a fixed period of two or three years.

Some variations of health insurance exist, often called disease insurance or critical illness insurance, but these are often inadequate as well. Typically, an individual pays additional or stand-alone premiums to cover specific adverse medical events (e.g. major surgery, cancer, etc.) for this type of insurance policy. Furthermore, this type policy often has rigidly prescribed payout terms and amounts that often provide only an incremental benefit. For example, many cancer insurance policies have fixed dollar limits such that a policy may only pay up to $1,500 for surgery costs or $1,000 for radiation therapy, or it may have fixed payments such as $50 or $100 for each day in the hospital. Others limit total benefits to a fixed amount such as $5,000 or $10,000.

Moreover, they are typically separate or not integrated with any other relevant insurance. Because they are not integrated, many cancer insurances, for example, do not cover cancer-related illnesses even though cancer or its treatment often leads to other physical problems, such as infection, diabetes, or pneumonia. Thus, due to their incremental, non-integrated nature, these policies typically are either very modest in their payouts or are very expensive in order to achieve adequate coverage.

Other types of policies pay only for hospital care in case an individual is hospitalized. These policies may also be in adequate because many individuals are no longer hospitalized for long periods of time or even hospitalized at all. For example, cancer care treatments, including radiation, chemotherapy, and some surgery, are often given on an outpatient basis without hospitalization. Indeed, the average stay in the hospital for a cancer patient is typically thirteen days. Moreover, many policies promise to increase benefits after a patient has been hospitalized for 90 consecutive days. However, since the average stay in a hospital for a cancer patient is only thirteen days, large dollar amounts for extended benefits have little value for most patients. As a result, a policy that pays for hospital care only when an individual is hospitalized generally has limited value.

Another type of insurance that an individual may obtain is often referred to as a critical illness or calamity policy. Such a policy is usually triggered by a designated medical condition (e.g., diagnosis of a critical illness such as a heart attack, paralysis, etc.), and upon triggering, the calamity policy simply pays the individual a certain amount of funds, sometimes in a lump sum, that the individual can use for car payments, mortgage payments, copays or deductibles, groceries, etc. Sometimes the funds may be utilized for medical care. However, calamity policies tend to be expensive for the amount of funds that they provide.

Yet another type of insurance that an individual may obtain is life insurance, but life insurance may also be inadequate to an individual in a life-expectancy reducing situation. Life insurance typically pays after death (known as the death benefit), which is obviously after the life-expectancy reducing condition no longer has to be treated.

An individual typically purchases life insurance in order to provide for his or her family after death, such as to provide money for the education of children, replace an income, payment of debt, etc. To that end, the insured individual or primary insured will name the beneficiary or beneficiaries that the primary insured wants the death benefit to be paid to.

A life insurance policy is obtained from a life insurance company, which is typically a company different from that which provides health insurance, either through an employer or individually, with the expectation that in return for payment of premiums to the life insurance company, the company will pay the death benefit amount to the policy beneficiaries in the event that the primary insured dies while the life insurance policy is in effect. A popular type of life insurance is term insurance, which will pay the death benefit if the primary insured dies during the term of the insurance (e.g., 1 year term, 5 year term, etc.) If the primary insured dies after the term, a death benefit will not be paid.

Variations in life insurance exist as well. For example, many life insurance companies include a rider on their term life policies that allows the payment of a portion of the policy's death benefit to be accelerated to the policy beneficiary(s) in the event the primary insured is diagnosed as terminally ill by a practicing, licensed physician. The policy beneficiaries may utilize the accelerated portion as they desire, which may include paying for treatment and/or medication of the primary insured. However, only a portion of the death benefit is accelerated, so at the most, the policy beneficiaries may be able to pay for treatments and/or medications up to the amount that was accelerated, which may still be inadequate due to the high costs.

The rider is usually called an Accelerated Death Benefit Rider or Living Benefit Rider, typically included with the term life insurance policy at no additional cost, and is subject to state availability. The amount accelerated is treated like a policy loan, and is deducted from the face amount of the policy along with any accrued interest and administrative fees. Because the accelerated amount is regarded as a loan with interest, the beneficiaries will typically be disadvantaged, and may not be adequately provided for after the primary insured's death.

In particular, each life insurance company typically has guidelines regarding the specific requirements of the rider. The chart (below) illustrates some of the guidelines and the general range across companies. The “life expectancy” is the amount of time the licensed physician expects the primary insured to live. The “amount allowed” is the percentage of the policy face amount the insurance company will ‘accelerate’ or payout. The “maximum amount” is typically the highest amount that a life insurance company will pay under the rider.

| | Life | Amount | Maximum |
|---|---|---|---|
| | Expectancy | Allowed | Amount |
| Range | 6-12 Months | 25%-75% | $250K-$500K |

Alternatively, a mechanism called “life insurance settlement” is also available whereby external investors purchase all the death benefit from an individual. Typically, purchase prices vary between 20% and 30% of the death benefit, which could then be used for any purpose. The estate of the individual ceases to have any further benefit from the life policy. Thus, although a portion of the death benefit may be received during the life of the insured at a hefty price, the beneficiaries will be disadvantaged and may not be provided for after the primary insured dies.

Typically, there are no established requirements or protocol for a life insurance company to be made aware of a change in the life expectancy of an individual, other than at policy sale or renewal.

A need therefore exists in the art for a process to better meet the financial needs of an individual facing a situation that may reduce life-expectancy.

### SUMMARY OF THE INVENTION

These and other problems associated with the prior art may be addressed through the use of feature, such as a rider or clause, in a life insurance policy that provides life extending expenses to an insured prior to death and in association with a life-expectancy reducing event such as cancer, a terminal illness, or an accident (e.g., a severe automobile accident, a severe motorcycle accident, a severe horseback riding accident, etc.), etc. The expenses are desirably used for healthcare costs and other costs associated with extending life expectancy, and thus hopefully extending an insured individual's life and delaying his or her death. Reflecting the mutual benefits to both the insured individual and to an insurer of a delay in the death of the individual (and thus from the perspective of the individual, prolonging his or her life, and from the perspective of the insurer, delaying the payment of death benefits), the feature is designed such that the funds to be paid under the feature are greater than any offset of the death benefit that may be caused by the feature. Thus, the beneficiaries of an individual taking advantage of the feature would still receive most if not all of the death benefits despite the insured receiving funds under the feature.

Consistent with one aspect of the invention, coverage for life extending expenses is provided in a life insurance policy by determining a cost of a feature associated with funds for use in paying for life extending expenses of an insured individual, and associating the feature with the life insurance policy. The funds are for use for at least one life-expectancy reducing event, and the life insurance policy includes a coverage period and a death benefit. Additionally, the funds provided by the feature for use in paying for the life extending expenses are greater than any offset of the death benefit under the life insurance policy caused by the feature, such that the feature provides encouragement to prolong the life of the insured individual and delay payment of the death benefit.

Consistent with another aspect of the invention, coverage is provided for life extending expenses in a life insurance policy by associating with a life insurance policy a feature associated with funds for use in paying for life extending expenses of an insured individual related to at least one life-expectancy reducing event, where the life insurance policy includes a coverage period and a death benefit, and where the funds provided by the feature for use in paying for the life extending expenses is greater than any offset of the death benefit under the life insurance policy caused by the feature; and, in response to a life-expectancy reducing event, dispensing funds to the insured individual under the feature and prior to the insured individual's death for use in paying for life extending expenses, where the feature provides encouragement to prolong the life of the insured individual and delay payment of the death benefit.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of a distributed implementation of a life insurance system consistent with the principles of the present invention.

FIG. 2 is an exemplary LIFHMET feature routine to be executed by the life insurance system of FIG. 1 consistent with the principles of the present invention.

FIG. 3 is one example of a Premier Provider Formulary consistent with the principles of the present invention.

FIG. 4 is one example of the LIFHMET feature consistent with the principles of the present invention.

FIG. 5 is one example of various factors that may be utilized to determine a percentage increase in insurance premiums for the LIFHMET feature consistent with the principles of the present invention.

FIG. 6 is one example of various factors that may be utilized to determine a contribution to be paid by a healthcare provider for a formulary position consistent with the principles of the present invention.

FIG. 7 is another exemplary LIFHMET feature routine consistent with the principles of the present invention.

FIG. 8 is a more detailed diagram of the medical network referenced in FIG. 1.

FIG. 9 is an exemplary medical network routine consistent with the principles of the present invention.

The accompanying drawings, which are incorporated in and constitute a part of this specification, illustrate embodiments of the invention and, together with a general description of the invention given below, serve to explain the principles of the invention.

### DETAILED DESCRIPTION OF THE INVENTION

Provided herein is a process, including a computer implemented process, for making financial resources available for the healthcare costs and other life extending expenses associated with or related to the treatment of life-expectancy reducing illnesses, conditions, or situations such as cancer, a terminal illness, an accident (e.g., a severe automobile accident, a severe motorcycle accident, a severe horseback riding accident, etc.), etc. through the use of life insurance policies. A life-expectancy reducing Illness, condition, and/or situation may be utilized interchangeably herein, or may be collectively referred to as a life-expectancy reducing event. Furthermore, life-expectancy with a hyphen between life and expectancy and life expectancy without a hyphen may be used interchangeably herein.

In particular, an individual facing a life-expectancy reducing illness, condition, and/or other situation typically wants to address that issue and extend their life. This includes taking advantage of any medical treatment and/or medication that may extend their life. Furthermore, although life insurance companies typically have no connection with health insurance companies, a life insurance company has the prospect of a direct financial gain in taking cost-effective measures to extend the life of an insured individual. This is because death leads to payment of the insured's death benefit. Indeed, from a financial perspective, an extended lifespan may generate an incremental investment return on the amount that the life insurance company will eventually payout as a death benefit, and the longer that payment can be delayed, the higher the investment return may be. Moreover, again from a strictly financial perspective, it may be cost effective to extend the insured's life beyond the finite term of any term life insurance policy that the insured may carry, for example, in order for the life insurance company to avoid paying a death benefit altogether.

Consistent with the principles of the present invention, the mutual best interest of the insured individual and the insurance company in extending the life of an insured individual may be aligned, benefiting both the individual afflicted with a life-expectancy reducing condition and the life insurance company. Specifically, consistent with the principles of the present invention, a feature or rider may be added to an insurance policy to provide a sum of money to the insured to be directed toward healthcare costs associated with extending life expectancy. The policy could be a term life insurance policy, whole life insurance policy, among others, and the rider may be added either during the initial application process or later on after the policy is effective, but before the policy ends, to provide the desired sum of money to the insured. This amount of money may or may not affect the death benefit paid to the insured's beneficiaries. This feature may be referred to herein as a Life Insurance Funded Heroic Medical Efforts Trust (LIFHMET).

Specifically, the feature would provide significant funds to be spent on life extending medical efforts, for example, including treatment procedures and surgeries or medicines and pharmaceuticals that are not normally covered by health insurance. These funds may be spent on appropriate medical intervention, medicines, and/or treatment anywhere in the world. For example, the funds may be utilized to meet deductible and co-pay requirements of health insurance and/or reasonable related expenses that are not covered by health insurance such as travel, lifestyle support, caregivers, etc.

In addition to utilizing a life insurance policy as a vehicle to help extend lives by providing funds, the feature may also provide access to a large network of medical professionals and medically oriented data associated with the life-expectancy reducing event the insured is facing to provide the insured with treatment and/or medication options (e.g., mainstream options such as chemotherapy and/or alternative options such as acupuncture), any studies on the success of these options, any studies on the life-expectancy reducing event and other relevant studies (e.g., studies on a different event that may be applicable to the event faced by the insured), lists of specialists for the event, recommendations (e.g, doctors, hospitals, treatment, medication, etc.), including recommendations from a premier provider formulary (or provider formulary or formulary for simplicity) associated with the network as well as recommendations not from the provider formulary associated with the network, pricing information, etc. Indeed, the insured may be provided access to this medical network when time is of the essence to the insured to assist the insured with making informed decisions about how he or she would like to proceed. After the insured makes his or her decisions, the insured may go on to contact the desired provider(s) associated with the desired option(s). For simplicity, this network will be referred to herein as a medical network, and may include practically anything associated with life-expectancy reducing events.

As such, an insured individual facing a life-expectancy reducing condition with this feature in their life insurance policy may activate its application by simply providing appropriate notification to their life insurance company of the life-expectancy reducing medical condition and diagnoses, for example. As long as the medical condition or disorder qualifies under the policy, the insured receives the designated funds under the feature, together with any complementary support and/or services the life insurance company chooses to offer (e.g., the medical network). With the funds, the insured is then able to seek the medical assistance necessary to extend his or her life. For simplicity, expenses to extend the insured life (e.g., medication bills, treatment bills, etc.) will be referred to herein as life extending expenses. An administrator or trustee dispenses the necessary funds for application to legitimate life-extending costs until the fund is depleted.

Moreover, in some embodiments of the invention, the funds are not treated as a loan, and do not otherwise affect the death benefit in the life insurance policy. In other embodiments, the funds may reduce the death benefit; however, reflecting the mutual benefits of the funds to both the insured and the insurer, the effect is reduced as compared to accelerated death benefits provided by conventional policies, many of which provide a dollar-for-dollar reduction, or in some instances, charge additional fees and/or interest. Of note, the funds provided by the feature for use to pay for the life extending expenses are desirably greater than any offset of the death benefit under the life insurance policy caused by the feature, i.e., the offset caused by addition of the feature to the policy, or alternatively, caused by activating the feature and receiving life extending funds under the feature. For example, if the death benefit is not affected at all, then there is no offset at all. However, even if the death benefit is affected, the funds paid under the feature (e.g., 15% of the death benefit) are greater than any offset (e.g., reduction) of the death benefit (e.g., 5% of the death benefit) paid to beneficiaries. In particular, if the insured has contracted for 15% of the death benefit of a life insurance policy with a $500,000 face payout to be paid under the feature, the insured will receive $75,000 under the feature. Furthermore, assuming the insured contracted for a reduction of 5% of the death benefit to be paid to the beneficiaries to account for the cost of the feature, the offset to the beneficiaries would be 5% of $500,000 or $25,000. Thus, the funds provided by the feature for use to pay for the life extending expenses ($75,000) are greater than any offset of the death benefit under the life insurance policy ($25,000). Greater may refer, for example, to any percentage that is greater, an amount that is greater, etc. to be paid to the insured for a qualifying life-expectancy reducing event under the feature. The offset may be a reduction, for example, in terms of percentage, in terms of an amount, etc. to the death benefit paid to the beneficiaries under the life insurance policy in the event the feature is either added to the policy or used. Of note, the offset or reduction in the death benefit can be triggered as a result of adding the feature to the policy (such that the reduction occurs regardless of whether the feature is ever used) or as a result of activating and using the feature in response to a life-expectancy reducing event.

With respect to the insurance company, besides the potential financial gains provided to their economic bottom line by extending the insured's life, in the highly competitive marketplace for term life insurance, this feature also provides a competitive advantage in contrast to competitors offering only typical life insurance products. Indeed, the insured individual typically wants to prolong his or her life, which may in turn delay payment of the death benefit under the life insurance policy by the life insurance company. Thus, the feature takes advantage of the mutual best interests of the insured and the life insurance company.

Embodiments consistent with the principles of the present invention utilize a computer or other processing equipment to determine a percentage increase in life insurance premiums to account for the cost of the LIFHMET feature, to calculate a contribution by a healthcare provider to be applied to the cost of the feature in exchange for a position on the premier provider formulary (referred to herein as healthcare providers or simply providers, and may include manufacturers of equipment, pharmaceuticals or medications, etc., hospitals, physicians, etc.), and to otherwise associate the feature with a life insurance policy, among other functionality. Various factors are monitored and obtained from various networked databases to implement the benefits of the invention into a life insurance product. Embodiments consistent with the principles of the present invention may also utilize a computer to receive notification that an insured individual has been diagnosed with a life-expectancy reducing condition, confirm that a policy is in effect, confirm that a life-expectancy reducing condition is a qualifying condition, and administer the program to provide the funds under the feature, provide access to the medical network, among other functionality.

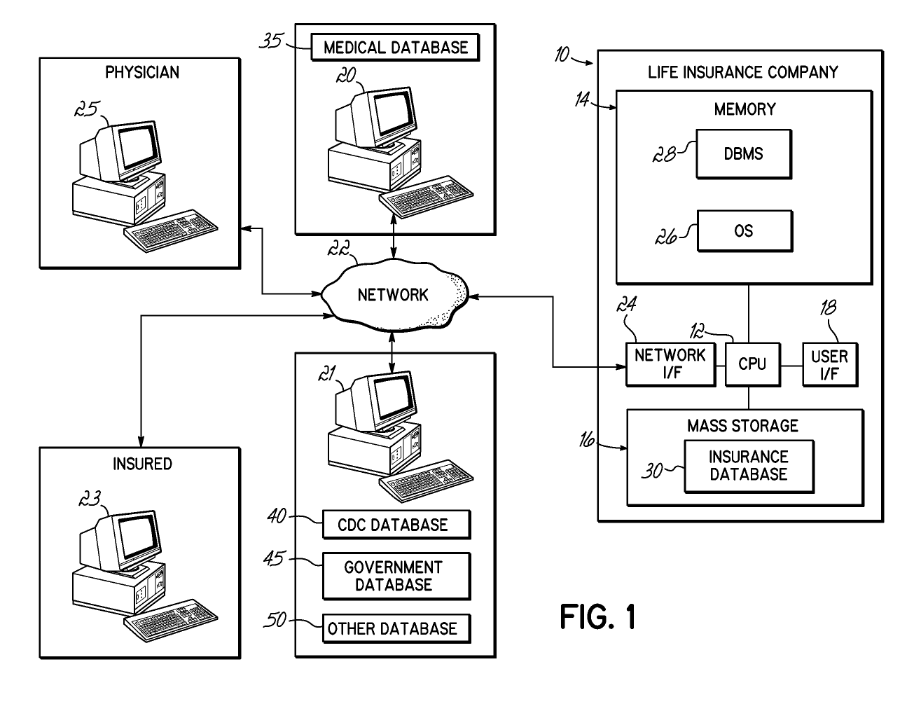

Turning now to the Drawings, wherein like numbers denote like parts throughout the several views, FIG. 1 illustrates an exemplary hardware and software environment for implementing the invention. For the purposes of the invention, an apparatus 10 may represent practically any type of computer, computer system or other programmable electronic device, including a client computer, a server computer, a single user computer, a portable computer, a handheld computer, an embedded controller, etc. However, it should be appreciated that computer 10 may also be implemented as a standalone workstation, desktop, or other single-user computer in some embodiments. Moreover, apparatus 10 may be implemented using one or more networked computers, e.g., in a cluster or other distributed computing system. Apparatus 10 will hereinafter also be referred to as a “computer,” although it should be appreciated that the computer 10 may also include other suitable programmable electronic devices consistent with the invention, as noted above. Computer 10 may be associated with or located at an entity providing the life insurance product that is part of the invention, referred to herein as a “life insurance company” for simplicity. Additionally, computer 20 and computer 21 may be similar to the computer 10, but the computers 20 and 21 may be associated with or located at entities other than the insurance company, such as a hospital and government, respectively. Likewise, a physician computer 25 and/or an insured computer 23 may be similar to computer 10 and/or associated with or located at entities other than the insurance company.

Computer 10 typically includes a central processing unit (CPU) 12 including one or more microprocessors coupled to a memory 14, which may represent the random access memory (RAM) devices comprising the main storage of the computer 10, as well as any supplemental levels of memory, e.g., cache memories, non-volatile or backup memories (e.g., programmable or flash memories), read-only memories, etc. Each CPU 12 is typically implemented in hardware using circuit logic disposed on one or more physical integrated circuit devices, or chips. Each CPU 12 may be one or more microprocessors, micro-controllers, field programmable gate arrays, or ASICs, while memory 14 may include random access memory (RAM), dynamic random access memory (DRAM), static random access memory (SRAM), flash memory, and/or another digital storage medium, typically implemented using circuit logic disposed on one or more physical integrated circuit devices, or chips. In addition, memory 14 may be considered to include memory storage physically located elsewhere in computer 10, e.g., any cache memory in a processor in CPU 12, as well as any storage capacity used as a virtual memory, e.g., as stored on a mass storage device 16 or on another computer coupled to computer 10.

Computer 10 also typically receives a number of inputs and outputs for communicating information externally. For interface with a user or operator, computer 10 typically includes a user interface 18 incorporating one or more user input devices (e.g., a keyboard, a mouse, a trackball, a joystick, a touchpad, and/or a microphone, among others) and a display (e.g., a CRT monitor, an LCD display panel, and/or a speaker, among others). For example, the input may be utilized to determine a percentage increase in life insurance premiums to account for the cost of the feature. Otherwise, input may be received via another computer or terminal, e.g., from computer 20 coupled to computer 10 over a network 22, from computer 21 coupled to computer 10 over a network 22, from computer 23 coupled to computer 10 over a network 22, and/or from computer 25 coupled to computer 10 over a network 22. As such, various of the elements of the invention may be implemented through a network of different components.

For example, medical related information (e.g., a diagnosis of a life-expectancy reducing condition, statistical information, etc.), as discussed further hereinbelow, may be transmitted from the computer 20 to the computer 10, and utilized by the life insurance company in implementing the invention. Additionally, other statistical information, information from the center for disease control (CDC), and/or other information may be transmitted from the computer 21 to the computer 10 via the network 22, and utilized at the location of computer 10.

For non-volatile storage, computer 10 typically includes one or more mass storage devices 16, and/or a tape drive, among others. Furthermore, computer 10 may also include an interface 24 with one or more networks 22 (e.g., a LAN, a WAN, a wireless network, and/or the Internet, among others) to permit the communication of information with other computers and electronic devices at other locations and sources. It should be appreciated that computer 10 typically includes suitable analog and/or digital interfaces between CPU 12 and each of components 14, 16, 18, and 24 as is well known in the art.

Computer 10 operates under the control of an operating system 26, and executes or otherwise relies upon various computer software applications, components, programs, objects, modules, data structures, etc. For example, a database management system (DBMS) 28 may be resident in memory 14 to access an insurance database 30 resident in mass storage 16. The insurance database 30 may include life insurance related information, for example, proprietary life insurance related information, data to generate life expectancy based on age, gender, race, location (e.g., New York vs. Florida), state of health, etc., data to generate the cost of conventional life insurance such as term life insurance, including data to generate premiums, etc. This insurance related information may be received via the user interface 18 or other sources (e.g., generated at the insurance company, generated from a life insurance association, etc.). Additionally, information that is received from elsewhere, for example, from the computer 20 (e.g., from the medical database 35) and/or the computer 21 (e.g., from the CDC database 40, government database 45, and other database 50) may be stored in the database 30. At least one of the databases may also contain actuarial information, actuarial tables, etc. Some or all of the information from these sources of information may be combined in database 30 and utilized to determine a cost of the feature, or alternatively, determine the percentage increase in life insurance premiums to account for the cost of the feature, among other functionality.

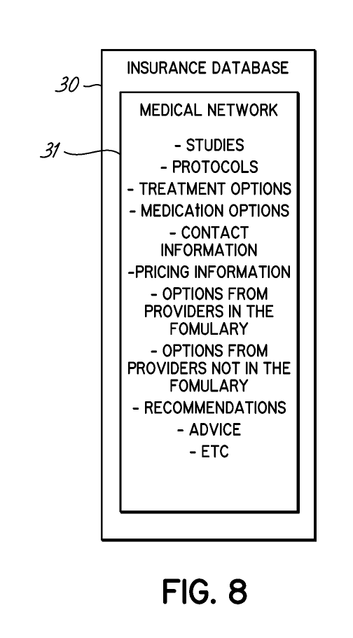

The insurance database 30 may also include the medical network 31 (FIG. 8). For example, the insurance database 30 may include data organized by life-expectancy reducing event that is associated with that event, including completed studies and ongoing studies, drug trials (and information for joining the drug trials if desired by the insured), protocols (e.g. treatment protocol), research, pricing information, available options, recommendations, providers in the premier provider formulary, providers that are not on the provider formulary, contact information of providers, contact information for support groups, contact information of other insured individuals experiencing the same or similar event that would like to share their experiences with other insured individuals, data on other events that may be applicable to the insured's event, etc. Indeed, those of ordinary skill in the art will appreciate that other data may be also be associated with a life-expectancy reducing event, such as the physician and/or hospital with the highest success rates for this event, and all of this data may be accumulated, for example, in the insurance database 30 or in another database at the life insurance company. Some or all of this data may be received from the computer 20 (e.g., from the medical database 35) and/or the computer 21 (e.g., from the CDC database 40, government database 45, and other database 50), the computer 25, as well as others, and stored in the database 30. An insured may be able to login to the database 30 from the insured computer 23 to access the data of the medical network on the database 30. Furthermore, the insurance company may setup a website, with the database 30 associated with the website, and as such the insured may be able to login to the website to access the medical network on the database 30.

It is also worth noting that an insured may be hospitalized or otherwise not be able to logon to access the medical network on the database 30 by him or herself, as such, this data may be provided to a relative of the insured, for example, that is assisting with the insured's care, or the insured may contact the insurance company and request data relevant to the event (e.g., medical version of a concierge). Furthermore, it is envisioned that a case worker, for example, may be designated by the life insurance company to assist the insured with life extending measures, helping the insured as much or as little as the insured desires, and the case worker may assist the insured using data from the medical network on the database 30. In some embodiments, the trustee or a person associated with the trustee that will administer the payment of the funds under the LIFHMET feature may obtain data associated with the insured's life-expectancy reducing event from the medical network on database 30 to assist the insured, provide the insured with options, etc. For example, the trustee may utilize a website set up by the insurance company, or the medical network may even be associated with the trustee and stored in a database associated with or located at the trustee's location.

As time is of the essence after a diagnosis of a life-expectancy reducing event, the database 30 and/or other components of the computer 10 may be organized or arranged to facilitated speedy access to data associated with a particular life-expectancy reducing event that is up to date, accurate, and credible (e.g., data is from a large established life insurance company instead of an unknown source) so that the insured may be provided with advice on relevant available options for his or her specific event. Again, the medical network is consistent with the mutual best interests of the insured and the life insurance company, namely, the insured will likely be seeking speedy advice regarding the event he or she is facing and the options for extending life and the life insurance company has an interest that the insured receives this advice and engage in life extending measures as soon as possible. Additionally, the life insurance company may also gain good publicity and/or a competitive advantage for maintaining the medical network and happier customers, as the customers know that they will have access to this medical network in case they face a life-expectancy reducing event. Indeed, via the LIFHMET feature, the life insurance company may become more medically oriented, with the best interest in extending the lives of the insured.

Moreover, various applications may also execute on one or more processors in another computer coupled to computer 10 via a network, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable signal bearing media used to actually carry out the distribution.

Examples of computer readable signal bearing media include but are not limited to physical and tangible recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

Each of the computers 20, 21, 23, and 25 may also include an operating system, at least one processor such as a central processing unit (CPU), a memory, including DBMS, mass storage, a database, a user interface, a network interface, and/or any routines executed to implement the embodiments of the invention, whether implemented as part of an operating system or a specific application, etc.

Specifically, in some embodiments, the computer 10, under control of the CPU 12, may determine a percentage increase in life insurance premiums (or other cost calculation other than percentage increase) to account for the cost of the LIFHMET feature, which makes funds available for any relevant treatment, medication expenses, etc. upon a diagnosis of a life-expectancy reducing event (e.g., diagnosis of a disease that substantially alters life-expectancy), by utilizing data in the insurance database 30. Furthermore, the computer 10 may calculate a contribution by a health care provider to be applied to the cost of the LIFHMET feature in exchange for a position on a provider formulary, as well as associating the feature with a life insurance policy so that the insured is covered by the LIFHMET feature, among other functionality. Furthermore, the computer 10 may monitor for and obtain data from various networked databases such as the medical database 35, the CDC database 40, the government database 45, and/or other database 50 and aggregate the data in the database 30 for use by the computer 10.

The embodiments may also receive notification at the computer 10, again under control of the CPU 12, from the hospital computer 20, the physician computer 25, and/or even the insured computer 23 via the network 22 that an insured individual has been diagnosed with a life-expectancy reducing event. Based on this notification, the computer 10 may confirm that a policy with a LIFHMET feature is in effect, confirm that a life-expectancy reducing event is a qualifying event, administer the program (or initiate administration of the program) to provide the funds under the feature, provide access to the insured or other person to the data of the medical network, among other functionality. Access to the data of the medical network may be provided as soon as all the confirmations have passed, even before the LIFHMET funds are paid into a trust for the insured, so that the insured can start accessing the data of the medical network and getting advice on the event he or she is facing as soon as possible, thereby minimizing a waste in precious time.

Those skilled in the art will recognize that the exemplary environment illustrated in FIG. 1 is not intended to limit the present invention. Indeed, those skilled in the art will recognize that other alternative hardware and/or software environments, as well as other modifications, may be used without departing from the scope of the invention.

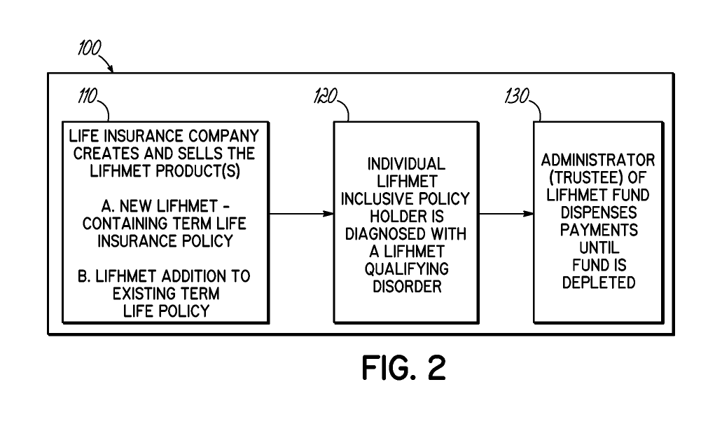

Turning now to FIG. 2, this figure illustrates an exemplary LIFHMET feature routine 100 for setting up the feature and use of the feature. In block 110, the life insurance company establishes and sells the LIFHMET product(s). This LIFHMET feature may be purchased, for example, with a new term life insurance policy. Alternatively, this feature may be added to an existing term life policy.

Creation of the LIFHMET product may involve defining the benefits or amount of funds to be paid out to the individual under the feature in case of a life-expectancy reducing condition and defining the costs to the individual for the feature within the confines of one or more traditional life insurance products. The amount to be paid out under the LIFHMET feature may be a percentage of the life insurance payout, and it will be paid to the insured (e.g., via a trust) if the insured faces a life expectancy reducing event during the term of the term life insurance policy, assuming the policy is still in effect. For example, the payout of the LIFHMET product to the insured may be $75,000, assuming a payout award of 15% of a $500,000 term life insurance policy (i.e., the life insurance policy has a face value of $500,000).

An individual may purchase about 15% to about 25% of the death benefit in the life insurance in some embodiments of the invention. Alternatively, an individual may purchase about 10% to about 15% of the death benefit in the life insurance in some embodiments of the invention. However, just about any other percentage or amount may be contracted for under the LIFHMET feature, for example, in some embodiments, the individual may purchase about 10% to about 50%, and the cost of the LIFHMET feature will reflect the contracted for percentage or amount.

However, it is worth noting that life insurance companies may follow eligibility protocols for the LIFHMET feature similar to eligibility protocols for issuing typical life insurance policies. For example, approval of a LIFHMET feature on a term life insurance policy may be subject to confirmation that the individual seeking the LIFHMET feature is not already facing a life-expectancy reducing event. Furthermore, life insurance companies may not approve the LIFHMET feature for preexisting conditions, for example, but once the life insurance finds the LIFHMET feature acceptable for an individual, then that insured individual may be able to invoke the LIFHMET feature upon a life-expectancy reducing event during the duration of the policy without the same concerns discussed in the Background hereinabove.

Creation of the LIFHMET product may also involve establishing the life-expectancy reducing conditions or situations (i.e., life-expectancy reducing event) that will qualify for the payout. The International Statistical Classification:0 to 10% of diseases and related health problems, 10^{th} edition (1992), as well as other guides, may be utilized to establish qualifying conditions.

Lastly, any additional benefits, for example, discounts from a provider formulary or assistance with the cost of the LIFHMET feature may be established. In some embodiments of the invention, a mechanism for healthcare goods and services providers to financially support an insurance pool of LIFHMET insured individuals may be established to enable these consumers to better afford healthcare services and products to extend their lives in accordance with one aspect of the invention. Specifically, competing healthcare providers (e.g., pharmaceutical companies, hospital systems, etc.) may both a) encourage the use of their own products and b) extend the prevalence of LIFHMET by contributing financially to insurance premiums in exchange for favorable formulary positioning.

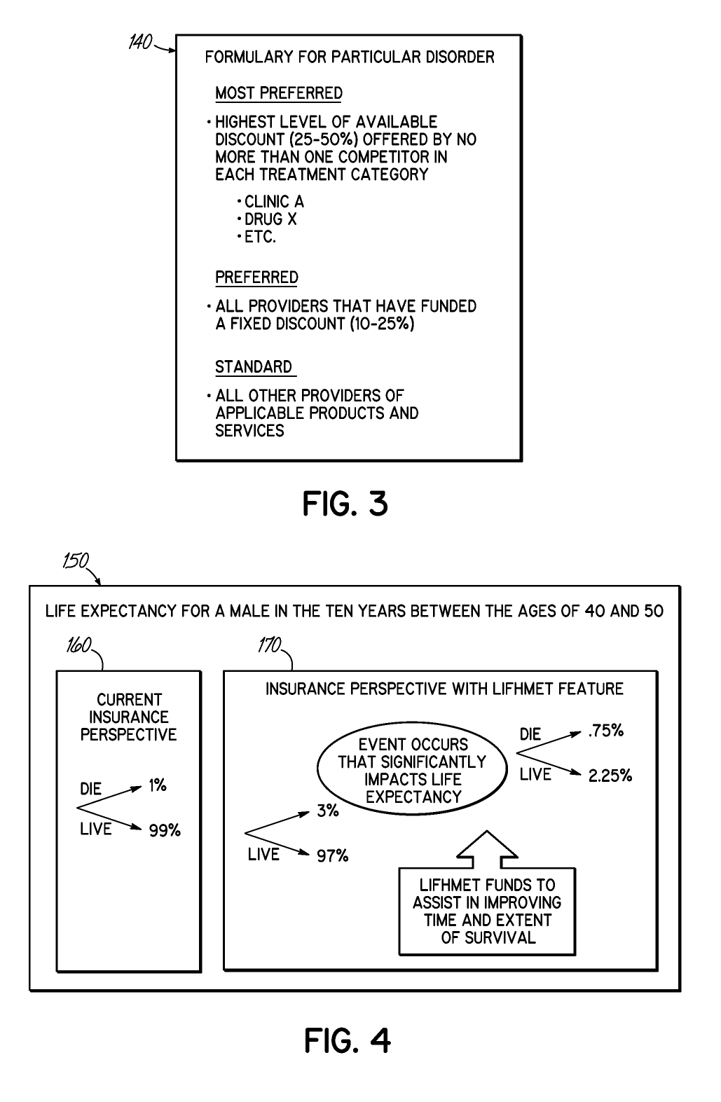

“Formulary positioning” refers to a categorization of treatments, providers, therapies, and drugs, among others, that reflect available price reductions to LIFHMET beneficiaries (i.e., insured). Indeed, the manufacturers, providers, etc. may bid to achieve the formulary status they desire by offering contributions to LIFHMET policy premiums, which in turn may lower pricing and/or may lead to higher benefits for the insured. The different formulary positions may be based upon the disorder or condition, and may be most preferred, preferred, and standard. FIG. 3 elaborates further on these three different positions in formulary 140, including the level of discount that may be associated with the positions, if any, according to the invention. In particular, the discount for most preferred may be about 25% to about 50%, while the discount for preferred may be about 10% to about 25%. Other discounts percentages, as well as other benefits (e.g., free pharmaceuticals) are also possible.

For example, the drug of a pharmaceutical company that does not have a formulary position may cost an insured with the feature the conventional high cost, whereas a drug from a pharmaceutical company with a most preferred formulary position may cost an insured with the feature a much lower cost (e.g., reflecting an approximately 25% to an approximately 50% discount). The much lower cost may thus encourage the insured with the feature to purchase the drug from the pharmaceutical company with the most preferred formulary position. Likewise, a branded drug from a non preferred pharmaceutical company (e.g., standard status) may cost more than a branded drug from a preferred pharmaceutical company (e.g., preferred status). The cost of a drug may also depend in part on whether the drug is generic.

Manufacturers and providers may bid to achieve formulary status by offering contributions to LIFHMET policy premiums by enabling lower pricing and/or higher benefits for the insured. The contribution amount that may be charged for various formulary positions may be based on a break-even premium contribution calculation for a particular insured population, and determined generally by a formula involving various factors. For example, the incidence of a particular condition or disease would be demographically adjusted and empirically derived for a covered condition under the invention. Alternatively, one or more of the items in the formula may be considered a factor in determining the cost for a formulary position. Formula 300 in FIG. 6 illustrates an exemplary formula. In the formula 300, the first factor may be the projected disease incidence where product could be used, the second factor may include the incremental sales from favorable formulary positioning, the third factor may be the product gross margin, and the fourth factor may be the total population insured. The first three factors may be multiplied, and that product may be divided by the fourth factor of total population insured. The result may then be the amount of money that a provider could offer per insured and breakeven. However, this formula may vary, for instance, not all of the factors, multiplication, and/or division are necessary, consistent with the principles of the present invention. For example, alternatively, the break even premium contribution for a position on the premier provider formulary may also be thought of as follows: breakeven premium contribution/insured population=demographically adjusted empirically derived disease incidence X projected product/service cost X anticipated market share X competitive discount bid.

As an example, there may be 40 people per ten thousand in an age range (first factor). Outside of the LIFHMET feature, the provider may have a 15% share of the market. The provider projects that being in a preferred formulary position may result in a 30% share as opposed to 10% share if a competitor has this advantage over them. This difference (30%-10%) of 20% equates to specific dollar sales depending on the price and typical consumption of their product (second factor). As illustrated in the formula 300, this percentage may be multiplied by the projected disease incidence such as 20% of 40=8 users at $X total consumption per user. Next, pharmaceutical products typically have gross profit margins in excess of 85% (third factor). As illustrated in the formula 300, the margin may be multiplied by the expected sales difference to yield the incremental total profit available. This product may be divided by the total population insured of ten thousand (fourth factor). Based on this result, the healthcare provider may negotiate or bid for a formulary position. Indeed, anything better than the breakeven amount calculated with the formula 300 may be incremental profit to the healthcare provider.

In particular, a physician associated with the physician computer 25 and/or a hospital associated with the computer 25, for example, may calculate the breakeven value and convey the breakeven value to the physician and hospital. The physician and/or hospital may utilize to negotiate or bid for a formulary position. The breakeven point, for example, may be calculated under the control of the corresponding CPU with the data from the corresponding database. Alternatively, a breakeven value may calculated by the life insurance company under the control of the CPU 12 with the data from the database 30, and the various networked systems 20, 21, and the life insurance company may utilize this value in negotiations, as a minimum contribution amount required, etc. for a formulary position.

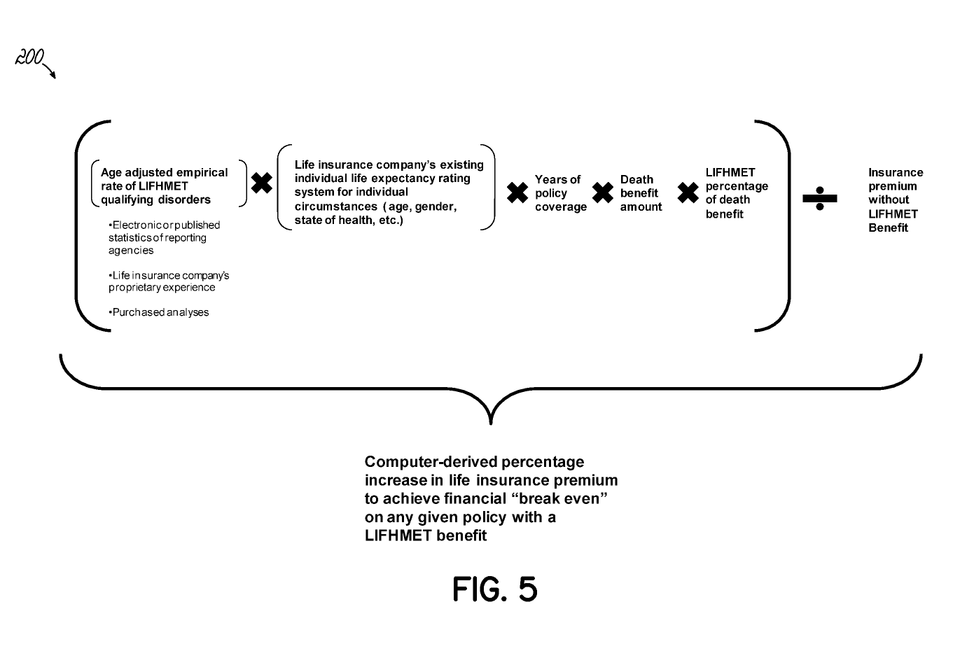

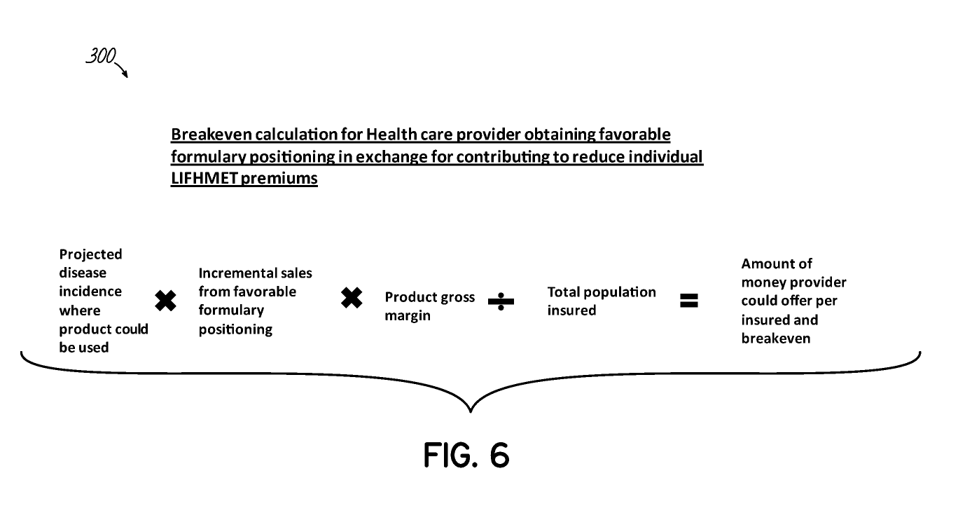

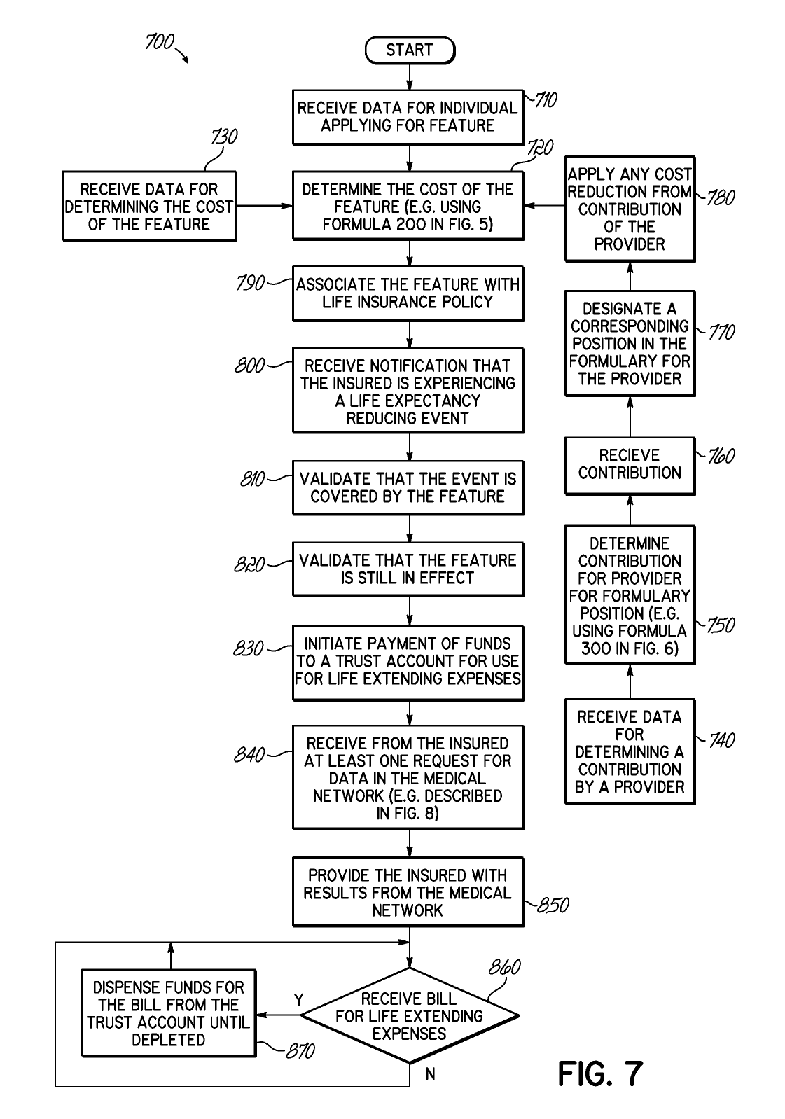

Returning to block 110 in FIG. 2, defining the casts associated with implementing the invention in a life insurance product may involve, for example, generating an incremental premium for the LIFHMET feature to be added to the cost of a term life insurance product. This cost may be a calculated under the control of the CPU 12 with the data from the database 30, and the various networked systems 20, 21. The computer-derived percentage increase or cost in a particular life insurance premium could be determined for a “break-even” cost for the particular life insurance product and policy. Alternatively, there could be a profit built in. A listing of factors that may be utilized to generate the percentage increase in the life insurance premium that achieves a financial breakeven point may be as follows: age adjusted empirical rate of LIFHMET qualifying disorders, the life insurance company's existing individual life expectancy rating system for individual circumstances (e.g., age, gender, race, location, state of health, smoker/non-smoker, etc.), years of policy coverage for the insured, death benefit amount, LIFHMET feature's percentage of death benefit for the insured to use for medical costs and procedures, among others. Also, the amount of the cost of the insurance premium without the benefit of the LIFHMET rider would be factored into the formula for determining the percentage premium increase to add the rider. These factors may be utilized on any given policy (e.g., whole life insurance, term life insurance, etc.) with a LIFHMET benefit. A exemplary formula 200 to determine the increase in cost is illustrated in FIG. 5, including possible multiplication and division of factors.

It is worth noting that some of the above-noted factors for determining a premium increase in accordance with the invention may additionally require separate calculations. For example, the age adjusted empirical rate of LIFHMET qualifying disorders may be based upon electronic or published statistics of various reporting agencies, the life insurance company's proprietary experience and/or purchased analyses. For example, various reporting agencies, such as the CDC, medical societies, and government entities, may provide desirable data via the remote networked systems 20, 21, as illustrated in FIG. 1.

The percentage increase for implementing a LIFHMET benefit onto an existing policy may be about 0% to about 10% of the existing premium. In particular, the percentage increase may be about 5% to about 10% of the existing premium. Nonetheless, a variety of factors may be utilized to generate the percentage increase, and the percentage increase will likely be lower in comparison to conventional health insurance. Other percentage increases or amounts are possible as well.

There may be various sources for funds to provide for the increased premium costs. First, the insured may just pay that increased cost. Alternatively, as indicated above, healthcare and pharmaceutical providers seeking a formulary position may contribute to the premiums for preferred positioning, which may reduce the percentage increase to the individual seeking the LIFHMET feature. Thus, premium contributions in exchange for a position on the premier provider formulary may be another factor to consider in generating the percentage increase, or alternatively, considered in order to reduce the generated percentage increase.

In another alternative, recovering the cost of the LIFHMET feature may also involve a reduction in the death benefit in the term life insurance. For example, if the feature is invoked, the death benefit might be reduced. The reduction may be, for example, about 5% to about 10%, or other percentage or amount. However, it will be appreciated that a reduction of about 5% to about 10% in the death benefit may still be lower than conventional reductions, and will generally be lower than the amount provided for life-extending funds under the feature.

In still another alternative, the life insurance company may decide that the financial benefit of delaying or investigating the death benefit payout is sufficient for them to absorb the premium increase under certain conditions. Also, the potential gain in market share that the insurance company might achieve implementing the LIFHMET rider may be sufficient to make the company absorb the premium increase.

Nonetheless, the LIFHMET product may be tailored for each individual, and may involve prompting the individual for information, defining the benefits or payout and costs, generating a cost for the feature based on a variety of factors, and finalizing the sale of the feature and accompanying life insurance policy. The various scenarios above of an increase in premium to the insured, decrease in death benefit, absorption of cost by the insurance company, and premium contributions by healthcare providers might all be used, in part or in whole, to arrive at a suitable source of funds to implement the invention. Once the policy is implemented, the LIFHMET feature may become effective.

Next, control may pass to block 120, in which a LIFHMET inclusive policy holder is diagnosed with a LIFHMET qualifying disorder. In particular, the insured individual may obtain written diagnoses from an initial physician and confirmatory physicians. The insured individual then files a LIFHMET claim by certified mail, or via a remote computer 23. The life insurance company validates the claim (e.g., via an expert panel) and funds the contracted LIFHMET trust fund. In some embodiments, one or all of these steps may be performed in an automated fashion, for example, the insurance company may be automatically sent a diagnosis from a networked physician computer 25.

Again, the potential sources of funds to be added to the trust fund may come from defined costs discussed in connection with block 110. The percentage increase in premiums (e.g., about 5% to about 10%) that the insured individual has been paying, and/or the slight reduction in death benefit (e.g., about 5% to about 10%), and/or the contribution to premiums by the providers in exchange for formulary positioning (e.g., preferred and most preferred positions in the premier provider formulary) and/or the costs absorbed by the insurance company may be used in part or in whole, for the purpose of funding the LIFHMET benefit.

As noted above, the premium costs may simply be absorbed by the life insurance company to reflect the financial benefit of delaying or mitigating death benefit payout and/or absorbed by the life insurance company to reflect the potential gain in market resulting from LIFHMET—inclusive life insurance products. For example, conventionally, the range of pricing for term life insurance may exceed 20%. Thus, a competitor at low end of pricing may be able to absorb the entire cost of the LIFHMET feature and still be within the current range. In such a case, a life insurance company may provide a “no-premium” version of LIFHMET by simply implementing the notification and validation portions. In this alternative, policy holders would be asked to notify the life insurance company at the event of a life-expectancy shortening condition, and the insurance company would use its expert panel and financial resources to offer services that it believes could extend the life of the individual.

Next, control may pass to block 130 of FIG. 2, in which an administrator or trustee of the LIFHMET funds dispenses payments until the fund has been depleted. The insured may solicit medical advice as desired from which ever provider he or she desires, and may make all the expenditure decisions, as long as these are within the covered medical use terms of the feature.

Indeed, the insured may use the funds for any out of pocket expenses directly connected to the LIFHMET diagnosis and treatment. For example, the insured might obtain any medicine or treatment anywhere in the world. Although the terminology medicine/medication and/or treatment is utilized herein, those of ordinary skill in the art will appreciate that these terms are not meant to be limiting and may include practically anything that may assist with extending the life of the insured, and may include, but not limited to, getting second opinions from physicians, seeing mental health professionals (e.g., to deal with the stress and anxiety of a life-expectancy reducing event), herbal supplements, getting assistance with nutritional, getting assistance with weight management, getting assistance to stop smoking, etc. The funds may also pay co-pays or deductibles of amounts from treatments that are not covered by health insurance. Travel and related expenses to obtain treatment might also be covered using funds from the LIFHMET benefit. Although the insured will have access to the providers in the LIFHMET premier formulary, and the insured may use the funds in connection with the LIFHMET premier formulary, the insured may not be under any obligation to use the pre-negotiated provider discount schedule in the “Premier Provider Formulary”. Moreover, in the case where the insured already has formulary benefits through his or her health insurance, the LIFHMET premier formulary may provide additional benefits.

Furthermore, via the medical network, the insured may be provided with data regarding the life-expectancy reducing event that he or she is facing, including informed advice on relevant available treatment and/or medication options, even on “alternative” treatments and/or medications such as those that are not mainstream (e.g., conventional), recommendations on providers (e.g., providers on the formulary and providers not on the formulary), etc. The insured may be able to make informed decisions and also use the funds for the options desired by the insured.

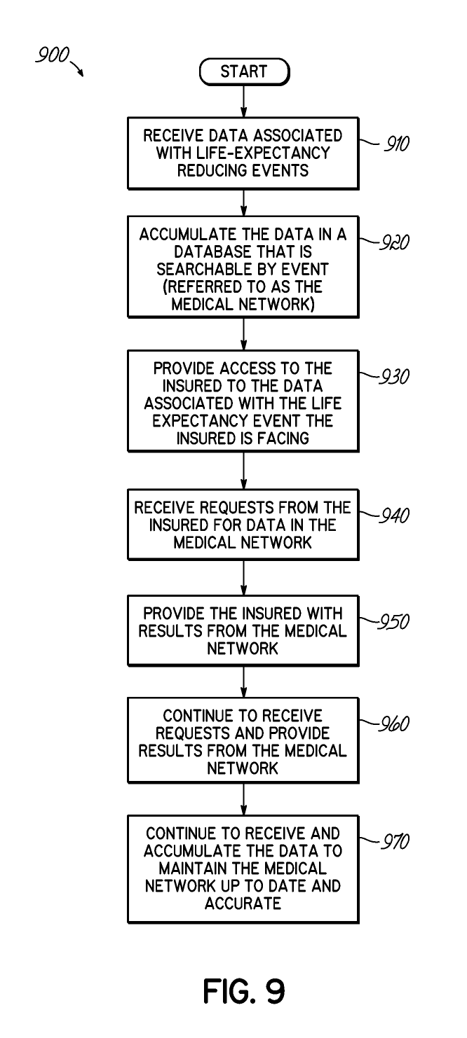

A medical network routine 900 is provided in FIG. 9. The routine 900 includes receiving data associated with the life-expectancy reducing events at the life insurance company, for example, or in connection with the website setup for the medical network, at block 910. Next, at block 920, the data may be accumulated in the database (e.g., the database 30) in a manner that the data is searchable by life-expectancy event. At block 930, access may be provided to the insured, which may include anyone authorized to assist the insured such as a relative, caregiver, person designated by the life insurance policy, etc., but for simplicity insured will be utilized. Specifically, the insured may be provided with data associated with the life-expectancy event the insured is facing. Upon the insured conducting a search in the medical network, one or more requests may be received from the insured for data in the medical network at block 940. At block 950, the insured may be provided with results to his or her request from the medical network. At block 960, the insured may continue to make requests, and these are received and results are provided from the medical network to the insured. At block 970, data associated with life-expectancy reducing events is continued to be received and aggregated or accumulated in the database to maintain the medical network up to date and accurate. Of note, various modifications may be made to this routine.

Returning to FIG. 2, in the event of death of the insured, the beneficiaries will still receive about 95% of the death benefit of the term life insurance policy (e.g., if the source of the funds was a decrease in death benefits of about 5%) or 100% of the death benefits if the source of the funds were the premiums, for example. Thus, with the LIFHMET feature, about 95% or more of the death benefit will still be paid to the beneficiaries from the life insurance policy.

A life insurance trustee may directly pay the provider and/or may simply reimburse payments of the insured. The trustee will generally administer the LIFHMET trust and funds. The trustee will provide guidance on available treatments and providers (e.g., from the formulary), and/or negotiate favorable rates. The trustee will also insure that the funds are going to proper expenses associated with extending the life expectancy of the insured. Of note, a more detailed LIFHMET feature routine 700 is illustrated in FIG. 7.

Turning to FIG. 7, this figure illustrates another exemplary LIFHMET routine 700 that may performed by the computer 10, under control of the hardware based CPU 12. At block 710, data is received from an individual applying for the LIFHMET feature. Such data may include medical history, is he or she a smoker, family history, age, as well as any other data the life insurance company may want to evaluate before approving the LIFHMET feature for the individual.

Next, control may pass to block 720 to determine the cost of the feature for the individual. The cost may be determined using formula 200 in FIG. 5. To determine the cost, block 730 may provide data, such as the data for the formula 200. Furthermore, the cost may be adjusted, for example, reduced, to account for a contribution by a provider. Thus, block 740 receives data for determining a contribution by a provider, and the contribution is determined at block 750 (e.g., using formula 300 from FIG. 6) in exchange for the position that the provider wants in the preferred provider formulary. Block 760 receives the contribution from the provider, block 770 designates the corresponding position in the formulary for the provider in exchange for the contribution, and block 780 may apply any cost reduction from the contribution of the provider to the cost determined at block 720.

Next, control may pass to block 790 to associate the feature with the life insurance policy. Specifically, associating the feature with the life insurance policy may be performed with the computer 10, under control of the hardware based CPU 12, and may include operations such as linking the LIFHMET feature to the corresponding life insurance policy of the insured individual, updating a computer record associated with the life insurance policy (e.g., in the database 30) to indicate that the feature is incorporated into the policy, creating documentation linking the feature to the life insurance policy, finalization of all specifics under the LIFHMET feature (e.g., amount of funds to be paid under the LIFHMET feature, cost or no cost at all, qualifying life-expectancy reducing events, whether there is any affect on the death benefit paid to beneficiaries of the life insurance policy, contracting for specifics, etc.) assuming the life insurance company has agreed to the individual's application for the LIFHMET feature, etc. Of note, updating the computer record may include adding data to a record for an existing life insurance policy of the insured to indicate that the feature was incorporated or added to the policy. Updating the computer record may also include setting up a new computer record in the database 30 indicating a new life insurance policy with a LIFHMET feature for the insured, and showing the linkage,

Afterwards, if the insured individual faces a life-expectancy reducing event, the life insurance company may be notified of this event at block 800 (e.g., notification from the hospital of a terminal diagnosis, notification from the insured individual, etc). In response to the notification, block 810 validates that the event is covered by the feature, and block 820 validates that the feature is still in effect. For example, if the insured individual stops paying the cost of the feature, the feature may be ineffective and dropped from the life insurance policy. Alternatively, the term of the life insurance policy may have already ended, and thus, coverage under the feature has also ended. The life insurance company may perform other validations as well.

Assuming that the validations are successful, control may pass to block 830 to initiate payment of funds to a trust account for use by the insured individual for life extending expenses. Also, the insured individual will be provided access to the medical network, for example, via a website he or she can login to in order to conduct searches for the life-expectancy reducing event that he or she is facing. Thus, block 840 receives from the insured at least one request (e.g., search inquiry) for data in the medical network. The medical network is described further in connection with FIG. 8. And block 850 may provided the insured individual with results from the medical network.

Next, block 860 determines whether a bill has been received for life extending expenses. If not, control may stay at block 860 to continue to determine if any bills are received. If a bill is received, control may pass to block 870 to dispense funds with the computer 10, under control of the hardware based CPU 12, from the trust account for payment of the bill, e.g., generating a check, initiating a wire transfer, etc. for payment of the bill. Control may then pass to block 860 to determine whether any other bills for life extending expenses have been received, and if so, then block 870 dispenses funds for the bill from the trust account until the funds are depleted.

FIG. 4 illustrates an example 150 of the LIFHMET feature to convey how it may work in practice, and the results of extending the life of an insured individual, benefiting both the insured individual and the life insurance company providing the feature. Specifically, based on life expectancy for a male in the ten years between the ages of 40 and 50, about 99% may survive and about 1% may die, as illustrated in portion 160. Under the current insurance perspective, as illustrated in portion 160, the insurance company will learn about any life-expectancy reducing conditions, if at all, only after the 1% insured individuals have died and the life insurance company will pay the death benefits to the beneficiaries.

However, with the LIFHMET feature disclosed herein, in portion 170, assuming 3% of insured males may experience an event that significantly impacts life expectancy and will likely reduce life expectancy, instead of 1% of those 3% dying because they could not afford treatment and/or medication, for a total of 99% surviving, these 3% of insured individuals may be provided with LIFHMET funds to assist in improving time and extending their lives. As such, an additional 0.25% may survive for at least a significant amount of time, for example, beyond age 50, for a total of 99.25% survival. Thus, an additional 0.25% of insured individuals may benefit by extending their lives (i.e., 99.25% vs. 99%), which also means that the insurance company may benefit by not having to pay the death benefits for the 0.25% of insured individuals. Furthermore, because more insured individuals may survive and the insurance company will pay fewer death benefits, the insurance company may be able to charge lower premiums while still making a profit, which may improve the insurance company's competitive advantage against other insurance companies. Moreover, providers in the premier formulary may benefit by providing their treatments and/or medication to one or more of the 3% of these insured individuals, which may increase the market share of the providers.

For the 2% that would have still survived beyond age 50, for example, the LIFHMET funds may provide them with access to treatment and/or medication that they would not be able to afford otherwise, and that which may extend their lives much longer than just past age 50. Moreover, providers in the premier formulary may benefit by providing their treatments and/or medication to these individuals, which may increase the market share of the providers.

Furthermore, for the 0.75% that may still die between age 40-50, these individuals may nonetheless benefit, for example, because the funds may allow them to extend their lives, even if the extension is not beyond the term of the insurance policy. As such, the life insurance company may still have to pay the death benefit, but the individuals were able to live longer. Moreover, providers in the premier formulary may benefit by providing their treatments and/or medication to these individuals, which may increase the market share of the providers.

Similarly, even if 1% still die between age 40-50, instead of the lower 0.75%, with 2% surviving beyond age 50, these individuals in the 1% may nonetheless benefit, for example, because the funds may allow them to extend their lives, even if the extension is not beyond the term of the insurance policy. Moreover, providers in the premier provider formulary may benefit by providing their treatments and/or medication to these individuals, which may increase the market share of the providers. As such, there may still be commercial benefits to the providers in the premier provider formulary and to the life insurance company (e.g., competitive advantage with term life insurance having LIFHMET feature over conventional term life insurance without it).

To continue the example, assume that the 3% of insured males in a group of 100 males (i.e., 3 males) experience an event that significantly impacts life expectancy (i.e., life expectancy reducing event) and invoke their LIFHMET benefits, with each of these males having a life insurance policy with a face value of $500,000. Moreover, if the LIFHMET benefit of each policy may be either 15% of face value (i.e., $75,000) or 10% of face value (i.e., $50,000), for example, and each of the three insured contracted for a LIFHMET feature that was 15% of the $500,000 face value, then the life insurance company would initiate payment of $75,000 into a trust account to be administered by a trustee for each insured. Thus, the maximum payment for the insurance company is $225,000 (225,000=3×$75,000) and the $225,000 may be derived from a variety of sources.

For instance, the source of the funds to be paid for each LIFHMET feature may be derived from the various sources discussed hereinabove as well as others. Specifically, in this example, the sources of funds may be obtained from the following: (1) Extension of life beyond policy term equaling about $50,000 to about $100,000, and/or (2) Reduction for ineligible “sudden death” equaling about $25,000 to about $50,000, and/or (3) Slight increase in premium (e.g., about 5% to about 10%) equaling about $25,000 to about $50,000, and/or (4) Slight reduction in face payout equaling about $25,000 to about $50,000, and/or (5) Value of policy retention (vesting) equaling about $50,000 to about $100,00, and/or (6) Formulary participants contribution equaling about $25,000 to about $50,000. Based on these values, the sources of funds may total about $200,000 to 400,000 to satisfy the LIFHMET benefits, and can satisfy the required $225,000 (or $150,000 if each of the three insured had contracted for 10%, or any variation (e.g., the first contracted for 8% of face value of the life insurance policy, another contracted for 11.2%, and the last contracted for 15%). However, not all of these six sources may be applicable, for example, a slight increase in premium (i.e., option (3)) may be utilized instead of a slight reduction of face payout (i.e., option (4)), but one or more of the sources of the funds may be sufficient to cover the LIFHMET payments to the insured.

Of note, option (2) regarding reduction for ineligible “sudden death” refers to circumstances where the insured suddenly dies (e.g., sudden fatal heart attack, suicide, etc.) before ever facing a life-expectancy reducing event and there is no way to assist the dead insured to extend his or her life. As such, the life insurance company may not need to pay the LIFHMET feature, which may result in a savings for the life insurance company. Of course, in such a circumstance, the insured's beneficiaries would still receive payment of the applicable death benefit under the life insurance policy per the specifics of the policy, subject to any restrictions such as suicide.

Option (5) regarding value of policy retention (vesting) refers to the circumstance where the insured has been a loyal customer of the life insurance company consistently renewing his or her polic(ies) with the life insurance company, owns multiple insurance products (e.g., bundles automobile, home, and life insurance policies), etc., and as such, the life insurance company may have a savings because of the lower commissions it has to pay to insurance sales agents (e.g., commissions on policy renewals are typically lower than commissions on new policies). Indeed, the life insurance company may even encourage option (5) by offering to increase the LIFHMET feature from about 15% to about 18% of the face value of the policy for loyal customers. Any excess funds raised from the various sources may be utilized in a variety of ways, for example, excess funds may be utilized to pay the funds of the LIFHMET feature of one or more other policies, to reduce the cost of the LIFHMET feature (e.g., reduce premiums similar to the contributions by providers on the premier provider formulary) on other policies, etc.

Those of ordinary skill in the art will appreciate that the LIFHMET feature may lead to fewer people dying than under the current system. Furthermore, the mutual benefit of extending the lives of the insured may be accomplished. In particular, all three insured may utilize the medical network and use the funds to help extend their lives, including utilizing providers from the premier provider formulary. Indeed, across a plurality of years, a life insurance company may be better able to determine the amount of funds that it may need to pay under LIFHMET, better able to calculate the amount of funds to expect from the various sources of funds more accurately, etc.

Those of ordinary skill in the art will appreciate that many different variations of the invention from those described herein are also contemplated. For example, a single or multiple expert panels of advisors may be created that monitors and discusses and/or negotiates terms for all relevant treatment alternatives to inform and advise individuals in the use of their financial resources to target medical improvement, for example, as part of the medical network. Alternatively, multiple healthcare providers (e.g., pharmaceutical companies, hospitals, treatment facilities, physician groups, medical device manufacturers, etc.) may support adoption and usage of the principles of the present invention disclosed herein through either offering program discounts, subsidizing premiums or amplifying benefits (e.g. for a beneficiary cancer patient, pharmaceutical company X may offer all that is needed of drug Y for a capped amount of $Z).

Moreover, multiple life insurance companies may offer the principles of the present invention on a licensed basis—competing on lower premiums and higher relative available LIFHMET funds. One major life insurance or reinsurance company may “wholesale” the principles of the present invention to multiple life insurance companies. Alternatively, a collective buyer of healthcare goods or services (e.g. large health insurer, prescription benefit manager, etc.) may negotiate favorable provider terms/involvement and wholesale resulting products containing a “preferred provider” feature.

Those of ordinary skill in the art will appreciate that consistent with the principles of the present invention, funds may be available from or in connection with life insurance policies for the beneficial treatment of life-expectancy reducing conditions without materially affecting the ultimate payout of the actual life insurance policy. Moreover, life insurance based financial resources may be provided for a great majority of life-expectancy reducing conditions that are not starkly terminal. Indeed, the substantial resources of life insurance companies may be leveraged to work aggressively to extend the life of an insured person. Furthermore, also provided is a mechanism for healthcare goods and services providers to financially support an insurance pool that enables insured individuals with life-expectancy reducing conditions to better afford their products, and also provided is a medical network to assist the insured to quickly obtain advice and data associated with the life-expectancy reducing event he or she is facing that is up to date, accurate, and credible so that the insured can decide on how to proceed to try to extend his or her life. Indeed, provided herein is a medically oriented system that uses a life insurance policy and the mutual interest of the insured and the life insurance in a way that seeks to extend the life of the insured by providing funds and a medical network, among other items.

While the present invention has been illustrated by the description of the embodiments thereof, and while the embodiments have been described in considerable detail, it is not the intention of the applicant to restrict or in any way limit the scope of the appended claims to such detail. For example, not all of the steps disclosed herein have to be performed by a computer in some embodiments (e.g., some steps may be performed manually and others performed in an automated fashion by a computer). Moreover, the LIFHMET feature may be utilized even if a user already has private health insurance and/or under health insurance provide by the government. Additional advantages and modifications will readily appear to those skilled in the art. Therefore, the invention in its broader aspects is not limited to the specific details, representative apparatus and methods, and illustrative examples shown and described. Accordingly, departures may be made from such details without departure from the spirit or scope of applicant's general inventive concept.

What is claimed is:

1. A computer implemented method of providing coverage for life extending expenses in a life insurance policy, the computer implemented method comprising:
determining a cost of a feature associated with funds for use in paying for life extending expenses of an insured individual related to at least one life-expectancy reducing event, wherein the feature is to be associated with a life insurance policy of the insured individual, wherein the life insurance policy includes a coverage period and a death benefit, and wherein the funds provided by the feature for use in paying for the life extending expenses is greater than any offset of the death benefit under the life insurance policy caused by the feature; and
associating the feature with the life insurance policy, wherein the feature provides encouragement to prolong the life of the insured individual and delay payment of the death benefit.

2. The computer implemented method of claim 1, wherein determining the cost of the feature further comprises utilizing at least one of an age adjusted empirical rate of qualifying disorders, an existing individual life expectancy rating system for individual circumstances, the coverage period of the life insurance policy, the death benefit of the life insurance policy, a percentage of the death benefit of the life insurance policy associated with the feature, or cost of the life insurance policy without the feature.

3. The computer implemented method of claim 2, wherein determining the cost of the feature further comprises multiplying each of the age adjusted empirical rate, the existing individual life expectancy rating system, the coverage period, the death benefit, and the percentage, and dividing that product by the cost of the life insurance policy without the feature.

4. The computer implemented method of claim 1, further comprising:
receiving notification of a life-expectancy reducing event for the insured individual;
validating the life-expectancy reducing event for the insured individual; and
validating the feature is still in effect.

5. The computer implemented method of claim 4, in response to validating the life-expectancy reducing event for the insured individual, further comprising initiating payment of the funds for use to pay for life extending expenses of the insured individual related to the life-expectancy reducing event.

6. The computer implemented method of claim 1, further comprising
receiving at least one contribution from a healthcare provider;
applying the contribution towards the cost of the feature; and
designating a position to the healthcare provider in a provider formulary, wherein the provider formulary is associated with the feature.

7. The computer implemented method of claim 6, further comprising determining the contribution from the healthcare provider.

8. The computer implemented method of claim 7, wherein determining the contribution further comprises utilizing at least one of a projected disease incidence where a product could be used, an incremental sales from favorable formulary positioning, the product gross margin, or total population insured.

9. The computer implemented method of claim 8, wherein determining the cost of the feature further comprises multiplying the projected disease incidence by the incremental sales, further multiplying by the product gross margin, and further dividing by the total population insured.

10. The computer implemented method of claim 1, further comprising receiving at least one request from the insured individual for data associated with a life-expectancy reducing event of the insured individual from a medical network, wherein the medical network includes data associated with the life-expectancy reducing event.

11. The computer implemented method of claim 10, further comprising providing at least one result to the insured individual from the medical network in response to the request from the insured individual for data associated with a life-expectancy reducing event of the insured individual.

12. The computer implemented method of claim 1, further comprising continuously receiving and accumulating data associated with life-expectancy reducing events to maintain a medical network that includes data associated with life-expectancy reducing events.

13. The computer implemented method of claim 1, wherein associating the feature with the life insurance policy includes updating a computer record associated with the life insurance policy in an insurance database to indicate that the feature is incorporated into the policy.

14. An apparatus, comprising:
a memory;
at least one hardware based processor; and
program code resident in the memory and configured to be executed by the at least one processor to provide coverage for life extending expenses in a life insurance policy by determining a cost of a feature associated with funds for use in paying for life extending expenses of an insured individual related to at least one life-expectancy reducing event, wherein the feature is to be associated with a life insurance policy of the insured individual, wherein the life insurance policy includes a coverage period and a death benefit, and wherein the funds provided by the feature for use in paying for the life extending expenses is greater than any offset of the death benefit under the life insurance policy caused by the feature; and
associating the feature with the life insurance policy, wherein the feature provides encouragement to prolong the life of the insured individual and delay payment of the death benefit.

15. The apparatus of claim 14, wherein the program code is configured to determine the cost of the feature by utilizing at least one of an age adjusted empirical rate of qualifying disorders, an existing individual life expectancy rating system for individual circumstances, the coverage period of the life insurance policy, the death benefit of the life insurance policy, a percentage of the death benefit of the life insurance policy associated with the feature, or cost of the life insurance policy without the feature.

16. The apparatus of claim 15, wherein the program code is configured to determine the cost of the feature by multiplying each of the age adjusted empirical rate, the existing individual life expectancy rating system, the coverage period, the death benefit, and the percentage, and dividing that product by the cost of the life insurance policy without the feature.

17. The apparatus of claim 14, wherein the program code is further configured to receive a notification of a life-expectancy reducing event for the insured individual;
validate the life-expectancy reducing event for the insured individual; and
validate that the feature is still in effect.

18. The apparatus of claim 17, wherein the program code is further configured to, in response to validating the life-expectancy reducing event for the insured individual, initiate payment of the funds for use to pay for the life-extending expenses of the insured individual related to the life-expectancy reducing event.

19. The apparatus of claim 14, wherein the program code is further configured to
receive at least one contribution from a healthcare provider;
apply the contribution towards the cost of the feature; and
designate a position to the healthcare provider in a provider formulary, wherein the provider formulary is associated with the feature.

20. The apparatus of claim 19, wherein the program code is further configured to determine the contribution from the healthcare provider.

21. The apparatus of claim 20, wherein the program code is further configured to determine the contribution by utilizing at least one of a projected disease incidence where a product could be used, an incremental sales from favorable formulary positioning, the product gross margin, or total population insured.

22. The apparatus of claim 21, wherein the program code is further configured to determine the cost of the feature by multiplying the projected disease incidence by the incremental sales, further multiplying by the product gross margin, and further dividing by the total population insured.

23. The apparatus of claim 14, wherein the program code is further configured to receive at least one request from the insured individual for data associated with a life-expectancy reducing event of the insured individual from a medical network, wherein the medical network includes data associated with the life-expectancy reducing event.

24. The apparatus of claim 23, wherein the program code is further configured to provide at least one result to the insured individual from the medical network in response to the request from the insured individual for data associated with a life-expectancy reducing event of the insured individual.

25. The apparatus of claim 14, wherein the program code is further configured to continuously receive and accumulate data associated with life-expectancy reducing events to maintain a medical network that includes data associated with life-expectancy reducing events.

26. The apparatus of claim 14, wherein the program code is further configured to associate the feature with the life insurance policy by updating a computer record associated with the life insurance policy in an insurance database to indicate that the feature is incorporated into the policy.

27. A method of providing coverage for life extending expenses in a life insurance policy, the method comprising:
determining a cost of a feature associated with funds for use in paying for life extending expenses of an insured individual related to at least one life-expectancy reducing event, wherein the feature is to be associated with a life insurance policy of the insured individual, wherein the life insurance policy includes a coverage period and a death benefit, and wherein the funds provided by the feature for use in paying for the life extending expenses is greater than any offset of the death benefit under the life insurance policy caused by the feature; and
associating the feature with the life insurance policy, wherein the feature provides encouragement to prolong the life of the insured individual and delay payment of the death benefit.

28. The method of claim 27, wherein determining the cost of the feature further comprises utilizing at least one of an age adjusted empirical rate of qualifying disorders, an existing individual life expectancy rating system for individual circumstances, the coverage period of the life insurance policy, the death benefit of the life insurance policy, a percentage of the death benefit of the life insurance policy associated with the feature, or cost of the life insurance policy without the feature.

29. The method of claim 28, wherein determining the cost of the feature further comprises multiplying each of the age adjusted empirical rate, the existing individual life expectancy rating system, the coverage period, the death benefit, and the percentage, and dividing that product by the cost of the life insurance policy without the feature.

30. The method of claim 27, further comprising:
receiving notification of a life-expectancy reducing event for the insured individual;
validating the life-expectancy reducing event for the insured individual; and
validating the feature is still in effect.

31. The method of claim 30, in response to validating the life-expectancy reducing event for the insured individual, further comprising initiating payment of the funds for use to pay for life extending expenses of the insured individual related to the life-expectancy reducing event.

32. The method of claim 27, further comprising
receiving at least one contribution from a healthcare provider;
applying the contribution towards the cost of the feature; and
designating a position to the healthcare provider in a provider formulary, wherein the provider formulary is associated with the feature.

33. The method of claim 32, further comprising determining the contribution from the healthcare provider.

34. The method of claim 33, wherein determining the contribution further comprises utilizing at least one of a projected disease incidence where a product could be used, an incremental sales from favorable formulary positioning, the product gross margin, or total population insured.

35. The method of claim 34, wherein determining the cost of the feature further comprises multiplying the projected disease incidence by the incremental sales, further multiplying by the product gross margin, and further dividing by the total population insured.

36. The method of claim 35, further comprising receiving at least one request from the insured individual for data associated with a life-expectancy reducing event of the insured individual from a medical network, wherein the medical network includes data associated with the life-expectancy reducing event.

37. The method of claim 36, further comprising providing at least one result to the insured individual from the medical network in response to the request from the insured individual for data associated with a life-expectancy reducing event of the insured individual.

38. The method of claim 27, further comprising continuously receiving and accumulating data associated with life-expectancy reducing events to maintain a medical network that includes data associated with life-expectancy reducing events.

39. A method of providing coverage for life extending expenses in a life insurance policy, the method comprising:
associating with a life insurance policy a feature associated with funds for use in paying for life extending expenses of an insured individual related to at least one life-expectancy reducing event, wherein the life insurance policy includes a coverage period and a death benefit, and wherein the funds provided by the feature for use in paying for the life extending expenses is greater than any offset of the death benefit under the life insurance policy caused by the feature; and
in response to a life-expectancy reducing event, dispensing funds to the insured individual under the feature and prior to the insured individual's death for use in paying for life extending expenses, wherein the feature provides encouragement to prolong the life of the insured individual and delay payment of the death benefit.
